(19) United States
(12) Patent Application Publication
(10) Pub. No.: US 2006/0045276 A1
(43) Pub. Date: Mar. 2, 2006

(54) Stereophonic reproducing method, communication apparatus and computer-readable storage medium

(75) Inventor: Tatsuya Gamo, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/019,241

(22) Filed: Dec. 23, 2004

(30) Foreign Application Priority Data
Sep. 1, 2004 (JP) 2004-254628

(51) Int. Cl. H04R 5/00; H04R 5/02

(52) U.S. Cl. 381/17; 381/1; 381/310

(57) ABSTRACT

A stereophonic sound reproducing method receives audio information and dynamic image information transmitted from a transmitting end and reproduces sound and dynamic image, by generating position information of a sound source of the transmitting end based on the dynamic image information, and reproducing the audio information based on the position information of the sound source and reproducing stereophonic sound that takes into consideration-the position information of the sound source of the transmitting end.

### BACKGROUND OF THE INVENTION

This application claims the benefit of a Japanese Patent Application No.2004-254628 filed Sep. 1, 2004, in the Japanese Patent Office, the disclosure of which is hereby incorporated by reference.

1. Field of the Invention

The present invention generally relates to stereophonic reproducing methods, communication apparatuses and computer-readable storage media, and more particularly to a stereophonic reproducing method for reproducing stereophonic sound based on dynamic image information, a communication apparatus which employs such a stereophonic reproducing method, and a computer-readable storage medium which stores a program for causing a computer to reproduce stereophonic sound.

2. Description of the Related Art

Conventionally, as a method of reproducing stereophonic sound, there is a method which embeds in advance position information of a sound source within a dynamic image into information that is sent transmitted from a transmitting end. For example, the position information of a stereophonic sound source within the dynamic image is represented as a difference in right and left volumes of the stereo sound. In addition, in the case of a general stereophonic sound reproducing mechanism, the position information of the sound source is transmitted from the transmitting end which transmits the information, and a reproducing end moves the position of the sound source based on the position information of the sound source. In other words, the position information of the sound source is always transmitted from the transmitting end to the reproducing end in a form added to audio information. For this reason, in the case where the stereophonic sound information such as the position information of the sound source is not included in the information that is transmitted from the transmitting end, the reproducing end cannot reproduce the stereophonic sound.

A Japanese Laid-Open Patent Application No.8-305829 proposes a sound extrapolation method which gives presence by an icon or the like within a still image that is displayed in a main window and extrapolating sound at each moved position of the icon or the like. More particularly, a database of sound data is created in advance, and corresponding sound is reproduced when a user selects a position on a screen by clicking the position by an input device. For example, in the case of a still image of a picture having a stream in front of a forest, the sound of a wind is reproduced when the user clicks the forest, and the sound of flowing water is reproduced when the user clicks the stream.

A Japanese Laid-Open Patent Application No.9-247564 proposes a television receiver that realizes a user benefit function for supporting an audience based on audiovisual information output from a television camera. More particularly, an audience distance is measured by an automatic focusing mechanism of the television camera, and a signal processing is carried out to make an edge-adding contour emphasis and volume adjustment using one characteristic dependent on the audience distance, so as to make an audience support such as making an optimum image display and sound reproduction dependent on the audience distance.

A Japanese Laid-Open Patent Application NO.2002-41038 proposes a virtual musical instrument playing apparatus that synthesizes an image that is picked up by a video camera to an image of a virtual musical instrument, and enables a user to play the virtual musical instrument by moving while watching the synthesized image. More particularly, an operating position of a player for playing the musical instrument is detected, and an image including the virtual musical instrument and the image of the player are synthesized and displayed, so as to create instrument playing information from position information of fingertips of the player when two-dimensional contours of the virtual musical instrument and the player touch each other.

If the audio information transmitted from the transmitting end is monaural sound information and includes no stereophonic sound information, it is possible to add extrapolation information which enables the user to reproduce stereophonic sound at the receiving end (or reproducing end). But in this case, the load on the user is large if the extrapolation information needs to be added manually by the user. In addition, if the extrapolation information is to be generated automatically by measuring the audience distance using the automatic focusing mechanism of the television camera, for example, the sound reproducing system becomes complex and bulky. Moreover, in either case, the extrapolation information is generated at the receiving end (reproducing end) under closed conditions, and it is impossible to generate the position information of the sound source of the transmitting end, thereby making it impossible to reproduce stereophonic sound at the receiving end (reproducing end) by taking into consideration the position information of the sound source of the transmitting end.

Therefore, the conventional stereophonic sound reproducing methods have problems in that stereophonic sound cannot be reproduced at the receiving end (reproducing end) by taking into consideration the position information of the sound source of the transmitting end, unless the audio information transmitted from the transmitting end includes the position information of the sound source of the transmitting end. In other words, in the case of a video cell phone (portable telephone), for example, when the audio information transmitted from the transmitting end is monaural audio information and includes no stereophonic sound information, it is impossible to reproduce stereophonic sound that takes into consideration the position information of the sound source of the transmitting end, even if the receiving end (reproducing end) is provided with the stereophonic sound reproducing mechanism.

### SUMMARY OF THE INVENTION

Accordingly, it is a general object of the present invention to provide a novel and useful stereophonic sound reproducing method, communication apparatus and computer-readable storage medium, in which the problems described above are suppressed.

Another and more specific object of the present invention is to provide a stereophonic sound reproducing method, a communication apparatus and a computer-readable storage medium, which enables stereophonic sound to be reproduced at a receiving end (reproducing end) by taking into consideration position information of a sound source of a transmitting end, even if audio information transmitted from the transmitting end includes no stereophonic sound information.

Still another object of the present invention is to provide a stereophonic sound reproducing method for receiving audio information and dynamic image information transmitted from a transmitting end and reproducing sound and dynamic image, comprising a generating step generating position information of a sound source of the transmitting end based on the dynamic image information; and a reproducing step reproducing the audio information based on the position information of the sound source, and reproducing stereophonic sound that takes into consideration the position information of the sound source of the transmitting end. According to the stereophonic sound reproducing method of the present invention, it is possible to reproduce stereophonic sound at a receiving end (reproducing end) by taking into consideration the position information of the sound source of the transmitting end, even if the audio information transmitted from the transmitting end includes no stereophonic sound information. In addition, it is possible to reproduce the stereophonic sound by taking into consideration the position information of the sound source of the transmitting end, so as to realize a video telephone function and the like having presence, as long as the receiving end (or reproducing end) is provided with a hardware and/or software applied with the present invention, without the need to provide special hardware and/or software at the transmitting end.

A further object of the present invention is to provide a communication apparatus comprising a receiving part configured to receive audio information and dynamic image information transmitted from a transmitting end; a position information generating part configured to generate position information of a sound source of the transmitting end based on the dynamic image information; and a sound reproducing part configured to reproduce the audio information based on the position information of the sound source, and reproducing stereophonic sound that takes into consideration the position information of the sound source of the transmitting end. According to the communication apparatus of the present invention, it is possible to reproduce stereophonic sound at a receiving end (reproducing end) by taking into consideration the position information of the sound source of the transmitting end, even if the audio information transmitted from the transmitting end includes no stereophonic sound information. In addition, it is possible to reproduce the stereophonic sound by taking into consideration the position information of the sound source of the transmitting end, so as to realize a video telephone function and the like having presence, as long as the receiving end (or reproducing end) is provided with a hardware and/or software applied with the present invention, without the need to provide special hardware and/or software at the transmitting end.

Another object of the present invention is to provide a computer-readable storage medium which stores a program for causing a computer to receive audio information and dynamic image information transmitted from a transmitting end and to reproduce sound and a dynamic image, the program comprising a generating procedure causing the computer to generate position information of a sound source of the transmitting end based on the dynamic image information; and a reproducing procedure causing the computer to reproduce the audio information based on the position information of the sound source, and to reproduce stereophonic sound that takes into consideration the position information of the sound source of the transmitting end. According to the computer-readable storage medium of the present invention, it is possible to reproduce stereophonic sound at a receiving end (reproducing end) by taking into consideration the position information of the sound source of the transmitting end, even if the audio information transmitted from the transmitting end includes no stereophonic sound information. In addition, it is possible to reproduce the stereophonic sound by taking into consideration the position information of the sound source of the transmitting end, so as to realize a video telephone function and the like having presence, as long as the receiving end (or reproducing end) is provided with a hardware and/or software applied with the present invention, without the need to provide special hardware and/or software at the transmitting end.

Other objects and further features of the present invention will be apparent from the following detailed description when read in conjunction with the accompanying drawings.

### BRIEF DESCRIPTION OF THE DRAWINGS

FIG. 1 is a system block diagram showing an important part of an embodiment of a communication apparatus according to the present invention;

FIG. 2 is a flow chart for explaining an operation of the communication apparatus;

FIG. 3 is a diagram for explaining a process of detecting a position of a target object within a dynamic image;

FIG. 4 is a diagram for explaining a relationship of a position of a target object at a transmitting end and a position of the target object within a dynamic image that is displayed at a receiving end;

FIG. 5 is a diagram for explaining a virtual position at the receiving end that is imagined by a stereophonic sound process; and

FIG. 6 is a diagram showing an operation setting screen which enables selection of the stereophonic sound process.

### DESCRIPTION OF THE PREFERRED EMBODIMENTS

A description will be given of embodiments of a stereophonic sound reproducing method, a communication apparatus and a computer-readable storage medium according to the present invention, by referring to the drawings.

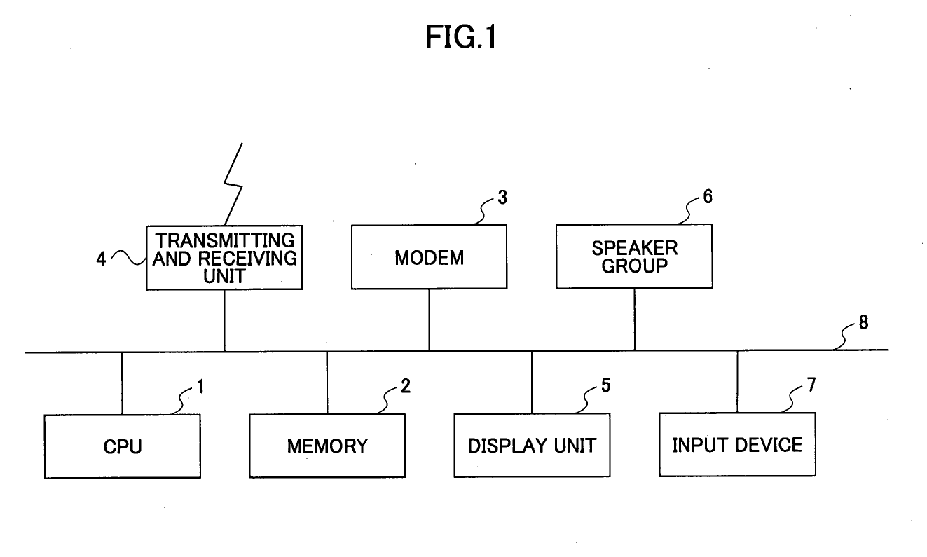

FIG. 1 is a system block diagram showing an embodiment of the communication apparatus according to the present invention. In this embodiment of the communication apparatus, the present invention is applied to a portable telephone having a dynamic image transmitting and receiving (or communication) function (that is, a video phone function). This embodiment of the communication apparatus employs an embodiment of the stereophonic sound reproducing method according to the present invention and an embodiment of the computer-readable storage medium according to the present invention.

A communication apparatus shown in FIG. 1 includes a CPU 1, a memory 2, a modem 3, a transmitting and receiving unit 4, a display unit 5, a speaker group 6 and an input device 7 that are connected via a bus 8. The CPU 1 controls the operation of the entire communication apparatus. The memory 2 stores programs to be executed by the CPU 1, and various data including intermediate data of operations carried out by the CPU 1. In this embodiment, the programs stored in the memory 2 include a program stored in this embodiment of the computer-readable storage medium, a program for realizing a stereophonic sound mechanism, and the like. The memory 2 is not limited to a semiconductor memory device such as a RAM, and may be formed by a storage unit such as a disk drive that uses one or more magnetic disks, optical disks or magneto-optic disks. In addition, the memory 2 may form this embodiment of the computer-readable storage medium.

When the communication apparatus operates as a transmitting end, the modem 3 modulates audio information and dynamic image information that are to be transmitted from the communication apparatus to a receiving end into a format conforming to a communication protocol, and the transmitting and receiving unit 4 transmits modulated information to the receiving end via a wireless (or radio) telephone line (not shown). On the other hand, when the communication apparatus operates as the receiving end, the transmitting and receiving unit 4 receives the modulated information from the transmitting end via the wireless telephone line, and the modem 3 demodulates the modulated information into the original audio information and dynamic image information depending on the communication protocol. A modem having a known structure for realizing the above modulating and demodulating functions may be used for the modem 3. Similarly, a transmitting and receiving unit having a known structure for realizing the above transmitting and receiving functions may be used for the transmitting and receiving unit 4. For the sake of convenience, it is assumed that the communication apparatus on the transmitting end has the functions of the so-called portable telephone having a built-in camera, the audio information is input at the transmitting end by a known method using a microphone or the like, and the dynamic image information is obtained by an image pickup unit or means (not shown), such as the camera, which picks up an image of a target object or the like.

The display unit 5 is formed a liquid crystal display (LCD) or the like, and displays menus and messages for the user when the user operates the communication apparatus, dynamic images of the received dynamic image information, and dynamic images of the dynamic image information that is transmitted. The speaker group 6 includes a plurality of speakers that are arranged to realize the video telephone function and the like having presence, and reproduce stereophonic sound from the received audio information by taking into consideration position information of a sound source. The input device 7 includes keys for inputting numbers and characters, keys for selecting functions, and the like.

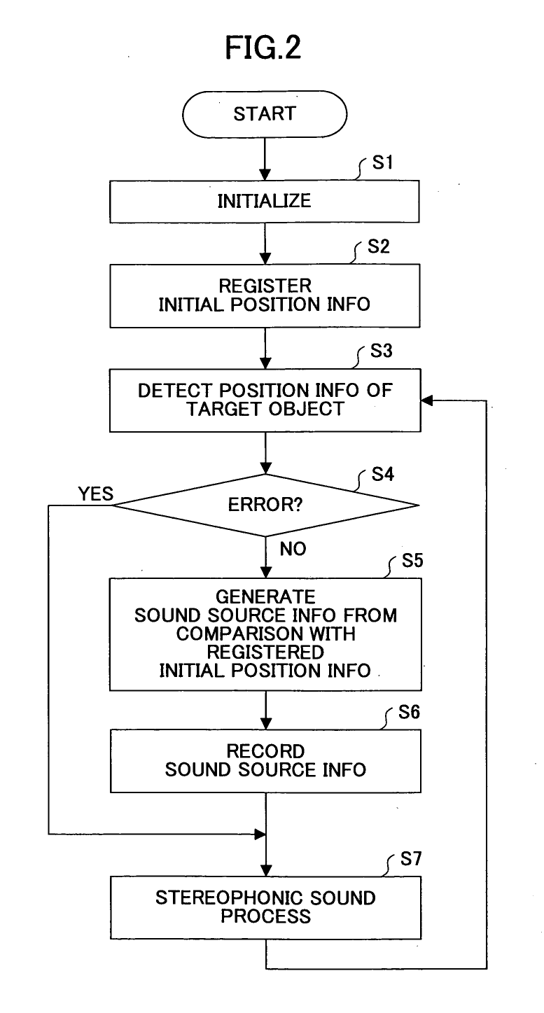

FIG. 2 is a flow chart for explaining an operation of the communication apparatus. The process shown in FIG. 2 corresponds to this embodiment of the stereophonic sound reproducing method. In addition, this embodiment of the computer-readable storage medium stores a program which causes a computer, such as the CPU 1, to carry out the process shown in FIG. 2. The process shown in FIG. 2 is started when the communication apparatus accepts a call from the transmitting end and operates as the receiving end, and this process ends when the connection with the transmitting end is disconnected.

In FIG. 2, a step S1 initializes various parameters that are necessary when carrying out the process shown in FIG. 2. A step S2 registers a target object within the dynamic image of the received dynamic image information, that is, initial position information of the sound source of the transmitting end, in the memory 2. The target object within the dynamic image may be an object or a person which occupies at least a predetermined amount of area within the dynamic image. In other words, a proportion (or ratio) of the area occupied by the target image with respect to the total area of the dynamic image is greater than or equal to a predetermined value. For the sake of convenience, it is assumed that initial position information of the target object within the dynamic image indicates a position having coordinates (0, 0) at a central portion of the display screen.

A step S3 detects, by a known detection method, position information of the target object within the dynamic image that is indicated by the received dynamic image information. The position information of the target object within the dynamic image may be obtained by detecting and tracking, from the contour and the like, the position of the object which occupies an area such that the proportion (or ratio) of the area occupied by the target image with respect to the total area of the dynamic image is greater than or equal to the predetermined value. In addition, the position information of the target object within the dynamic image may be obtained by detecting and tracking a portion that is recognized as a face of a person, such as a portion having skin color.

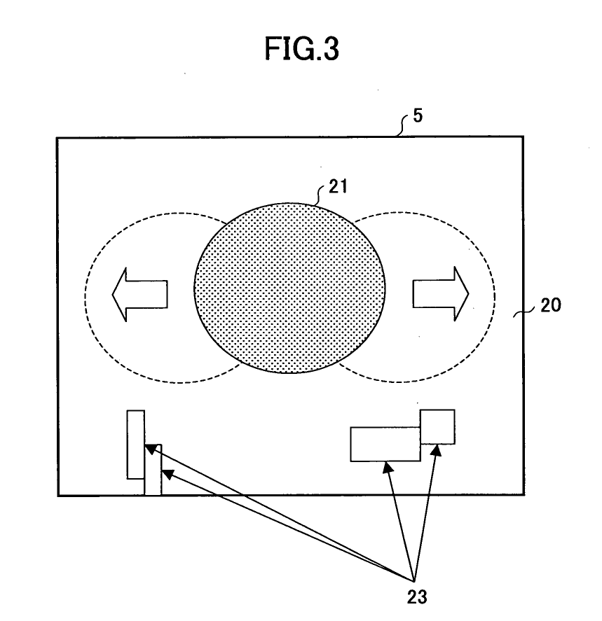

FIG. 3 is a diagram for explaining the process of detecting the position information of the target object within the dynamic image in the step S3. Of a dynamic image 20 that is displayed on the display unit 4, the step S3 employs the known detection method described above, and recognizes small objects 23 as background, and not as the target object (that is, the sound source of the transmitting end). Hence, when the proportion of the area occupied by an object within the dynamic image 20 is greater than or equal to the predetermined value or, an object within the dynamic image 20 is recognized as a person, this object is detected and tracked continuously as a target object 21.

A step S4 decides whether or not an error is generated at the position of the detected target object 21. In other words, if the target object at the transmitting end is outside an image pickup range that can be picked up by the image pickup unit (or means) and the target object 21 is not visible within the dynamic image 20, the step S4 detects that an error is generated. The process advances to a step S5 if the decision result in the step S4 is NO.

The step S5 generates the position information of the sound source of the transmitting end artificially and continuously, based on a comparison of the registered initial position information of the target object and the position information of the target object detected in the step S3. The position information of the sound source that is generated in the step S5 is obtained from relative coordinates with respect to the initial position information of the object, that is, the center coordinates (0, 0). For this reason, by comparing the position information of the target object that is successively obtained each time with the initial position information, it is possible to generate accurate position information of the sound source by carrying out a relatively simple operation. A step S6 records in the memory 2 the position information of the sound source that is generated in the step S5.

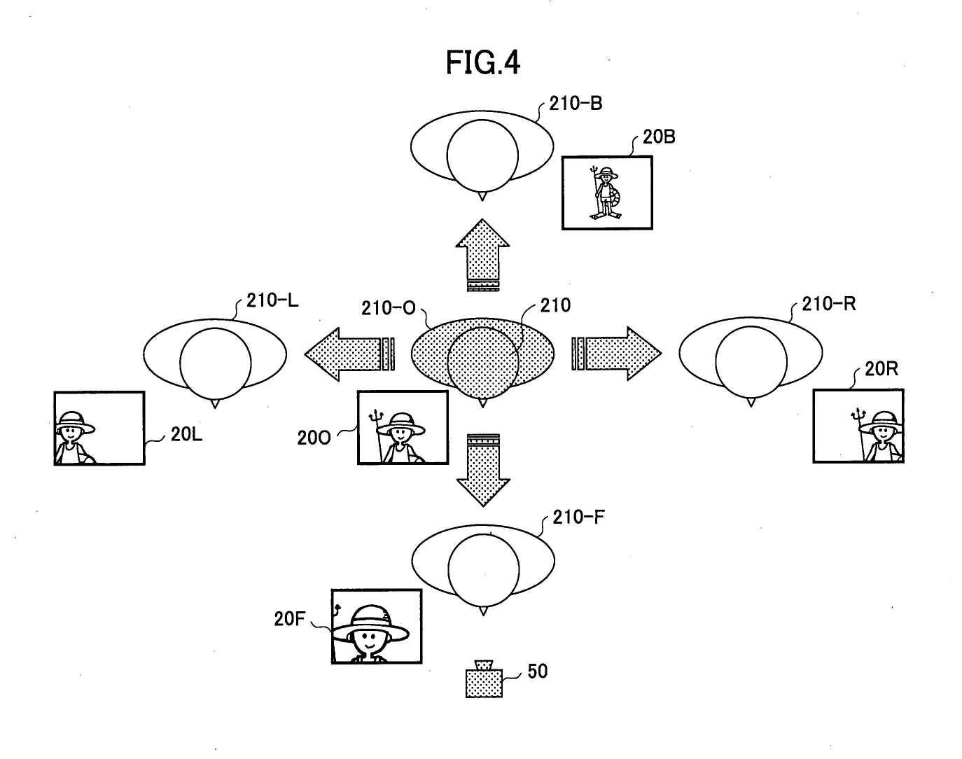

FIG. 4 is a diagram for explaining a relationship of the position of the target object at the transmitting end and the position of the target object within the dynamic image that is displayed at the receiving end. In FIG. 4, a target object (or object that is picked up or imaged) 210 is movable from a reference position 210-0 with respect to the position of a camera (image pickup unit or means) 50. The reference position 210-0 corresponds to the initial position of the target object 21 at the receiving end. When the target object 210 is located at the reference position 210-0, a dynamic image 200 is displayed on the display unit 5 at the receiving end. When the target object 210 moves backwards away from the camera 50 to a position 210-B, a dynamic image 20B in which the target object 21 has zoomed out is displayed on the display unit 5 at the receiving end. When the target object 210 moves towards the front and closer to the camera 50 to a position 210-F, a dynamic image 20F in which the target object 21 has zoomed in is displayed on the display unit 5 at the receiving end. When the target object 210 moves rightwards away from the camera 50 to a position 210-R, a dynamic image 20R in which the target object 21 has moved to the right is displayed on the display unit 5 at the receiving end. When the target object 210 moves leftwards away from the camera 50 to a position 210-L, a dynamic image 20L in which the target object 21 has moved to the left is displayed on the display unit 5 at the receiving end. Accordingly, as may be seen from FIG. 4, by detecting the position of the target object 21 within the dynamic image 20 at the receiving end, it is possible to artificially and continuously generate the position information of the sound source of the transmitting end.

A step S7 supplies to the stereophonic sound mechanism the position information of the sound source recorded in the memory 2, and the process returns to the step S3. The stereophonic sound mechanism subjects the received audio information to a known stereophonic sound process based on the position information of the sound source before supplying the audio information to the speaker group 6. For example, the known stereophonic sound process uses a head-related transfer function (HRTF). Hence, the stereophonic sound is reproduced by taking into consideration the position information of the sound source of the transmitting end. If the decision result in the step S4 is YES, the process advances to the step S7, and thus, the position information of the sound source is not generated in this case, and the stereophonic sound process is carried out based on the position information that is previously recorded in the memory 2.

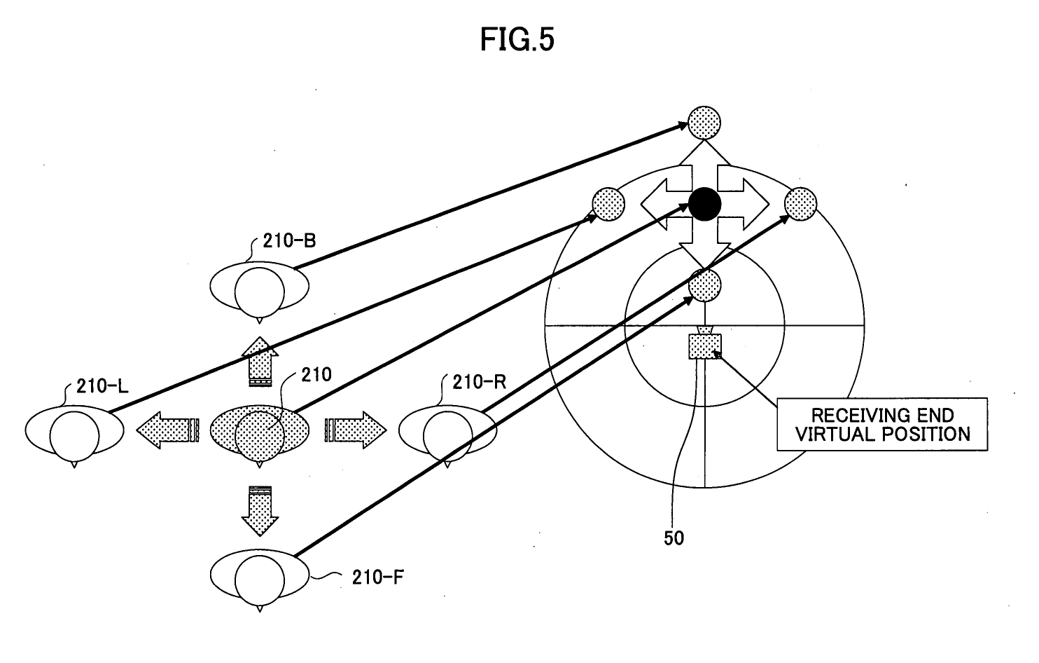

FIG. 5 is a diagram for explaining a virtual position at the receiving end that is imagined by the stereophonic sound process. In FIG. 5, those parts which are the same as those corresponding parts in FIG. 4 are designated by the same reference numerals, and a description thereof will be omitted. The dynamic image that is obtained by displaying the dynamic image information received by the communication apparatus on the display unit 5, is used to artificially generate the position information of the sound source of the transmitting end by detecting the position of the target object 210 of the transmitting end with respect to the receiving end (or reproducing end) virtual position, by regarding as if the user of the communication apparatus is at the position of the camera 50 shown in FIG. 5 at the transmitting end, that is, at the receiving end (or reproducing end) virtual position. Hence, the sound source position that is used to reproduce the stereophonic sound by the stereophonic sound mechanism moves as the target object 210 at the transmitting end moves, and it is possible to always accurately reproduce the stereophonic sound which reflects the actual position of the target object 210 at the transmitting end.

In this embodiment, the stereophonic sound mechanism is realized by a program stored in the memory 2. Hence, this embodiment of the computer-readable storage medium may store a combination of programs including the program which realizes the stereophonic sound mechanism.

Of course, the stereophonic sound mechanism may be realized by a hardware (semiconductor chip) that carries out a known stereophonic sound process. In this case, the stereophonic sound process can be carried out at a high speed, and a processing load on the CPU 1 can also be reduced. The hardware that carries out the stereophonic sound process may be connected to the bus 8 shown in FIG. 1.

For example, the stereophonic sound mechanism may use a software P3D manufactured by SONAPTIC and a semiconductor chip BU7844 manufactured by ROHM, so that a portion of a stereophonic sound algorithm is realized by the semiconductor chip (hardware).

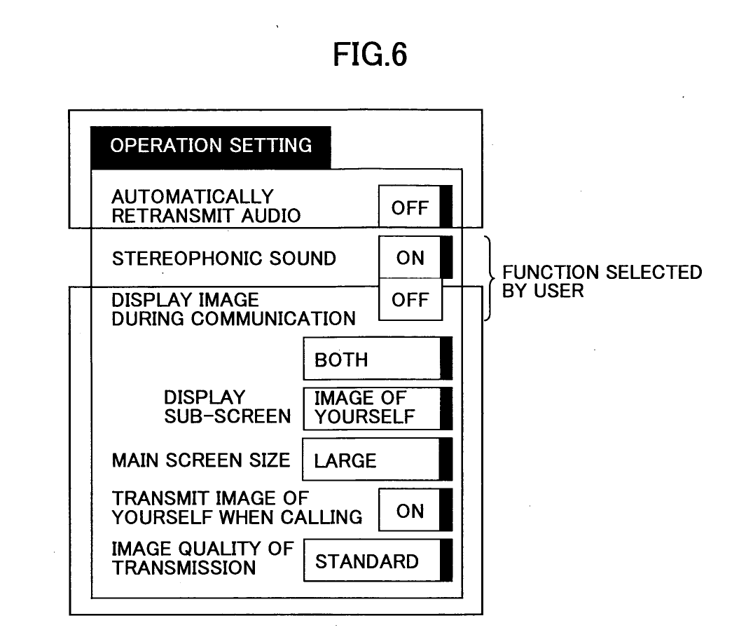

FIG. 6 is a diagram showing an operation setting screen which enables selection of the stereophonic sound process. The operation setting screen shown in FIG. 6 is displayed on the display unit 5 when a predetermined key or keys of the input device 7 is operated by the user of the communication apparatus. By making a key operation from the input device 7, the user can select functions such as “stereophonic sound” and “display image during communication (or display image in talk)”. For example, the “display image during communication” function is set to an “ON” state and activated when displaying on the display unit 5 not only the image received by the communication apparatus but also the image of the user of the communication apparatus. The functions other than the “stereophonic sound” function are not directly related to the subject matter of the present invention, and a description thereof will be omitted.

In FIG. 6, when the “stereophonic sound” function is set to an “ON” state and activated, the process shown in FIG. 2 is enabled. On the other hand, when the “stereophonic sound” function is set to an “OFF” state and deactivated, the process shown in FIG. 2 is disabled. When the “stereophonic sound” function is set to the “ON” state and activated, the position information of the sound source of the transmitting end is generated based on the dynamic image that is reproduced from the received dynamic image information, and by reproducing the audio information based on the position information of the sound source, the process of reproducing the stereophonic sound is carried out by taking into consideration the position information of the sound source of the transmitting end. The reproduction of the stereophonic sound is carried out by automatically and artificially generating the position information of the sound source of the transmitting end based on the dynamic image information that is received from the transmitting end. Hence, the communication apparatus on the transmitting end does not need to add, to the audio information that is transmitted, the sound source position information and the like for reproducing the stereophonic sound. In other words, no special process needs to be carried out in the communication apparatus on the transmitting end, and the reproduction of the stereophonic sound can be realized solely by the process carried out in the communication apparatus on the receiving end.

When generating the position information of the sound source of the transmitting end, the position information may be generated directly based on the received dynamic image information or, generated based on a dynamic image for display that is obtained by reproducing the received dynamic image information.

In the embodiment described heretofore, the present invention is applied to the portable telephone, and thus, the transmitting end and the receiving end are connected via a wireless telephone line. However, when the present invention is applied to the normal (cable) telephone, the transmitting end and the receiving end are of course connected via the normal telephone line. Moreover, the present invention may be applied to any type of communication apparatus as long as it has a function of communicating the audio information and the image information. Hence, the present invention can also be applied to a personal computer, a data terminal and the like having such a function of communicating the audio information and the image information.

Further, the present invention is not limited to these embodiments, but various variations and modifications may be made without departing from the scope of the present invention.

What is claimed is:

1. A stereophonic sound reproducing method for receiving audio information and dynamic image information transmitted from a transmitting end and reproducing sound and dynamic image, comprising:
a generating step generating position information of a sound source of the transmitting end based on the dynamic image information; and
a reproducing step reproducing the audio information based on the position information of the sound source, and reproducing stereophonic sound that takes into consideration the position information of the sound source of the transmitting end.

2. The stereophonic sound reproducing method as claimed in claim 1, wherein said generating step artificially generates the position information of the sound source of the transmitting end based on a position of an object that is within the dynamic image and occupies an area such that a proportion of the area occupied by the object with respect to a total area of the dynamic image is greater than or equal to the predetermined value.

3. The stereophonic sound reproducing method as claimed in claim 1, wherein said generating step artificially generates the position information of the sound source of the transmitting end based on a position of a person by detecting the position of the person within the dynamic image.

4. The stereophonic sound reproducing method as claimed in claim 1, wherein said generating step continuously detects a position of a target object within the dynamic image indicated by the dynamic image information, and artificially and continuously generates the position information of the sound source of the transmitting end based on the detected position of the target object.

5. A communication apparatus comprising:
a receiving part configured to receive audio information and dynamic image information transmitted from a transmitting end;
a position information generating part configured to generate position information of a sound source of the transmitting end based on the dynamic image information; and
a sound reproducing part configured to reproduce the audio information based on the position information of the sound source, and reproducing stereophonic sound that takes into consideration the position information of the sound source of the transmitting end.

6. The communication apparatus as claimed in claim 5, wherein said position information generating part artificially generates the position information of the sound source of the transmitting end based on a position of an object that is within the dynamic image and occupies an area such that a proportion of the area occupied by the object with respect to a total area of the dynamic image is greater than or equal to the predetermined value.

7. The communication apparatus as claimed in claim 5, wherein said position information generating part artificially generates the position information of the sound source of the transmitting end based on a position of a person by detecting the position of the person within the dynamic image.

8. The communication apparatus as claimed in claim 5, wherein said position information generating part continuously detects a position of a target object within the dynamic image indicated by the dynamic image information, and artificially and continuously generates the position information of the sound source of the transmitting end based on the detected position of the target object.

9. The communication apparatus as claimed in claim 5, further comprising:
a display unit configured to display the dynamic image indicated by the dynamic image information.

10. A computer-readable storage medium which stores a program for causing a computer to receive audio information and dynamic image information transmitted from a transmitting end and to reproduce sound and a dynamic image, said program comprising:
a generating procedure causing the computer to generate position information of a sound source of the transmitting end based on the dynamic image information; and
a reproducing procedure causing the computer to reproduce the audio information based on the position information of the sound source, and to reproduce stereophonic sound that takes into consideration the position information of the sound source of the transmitting end.

11. The computer-readable storage medium as claimed in claim 10, wherein said generating procedure causes the computer to artificially generate the position information of the sound source of the transmitting end based on a position of an object that is within the dynamic image and occupies an area such that a proportion of the area occupied by the object with respect to a total area of the dynamic image is greater than or equal to the predetermined value.

12. The computer-readable storage medium as claimed in claim 10, wherein said generating procedure causes the computer to artificially generate the position information of the sound source of the transmitting end based on a position of a person by detecting the position of the person within the dynamic image.

13. The computer-readable storage medium as claimed in claim 10, wherein said generating procedure causes the computer to continuously detect a position of a target object within the dynamic image indicated by the dynamic image information, and to artificially and continuously generate the position information of the sound source of the transmitting end based on the detected position of the target object.
